(19) United States
(12) Patent Application Publication
(10) Pub. No.: US 2026/0194926 A1
(43) Pub. Date: Jul. 9, 2026

(54) ELECTRONIC FLOW-CONTROL ASSEMBLY AND SYSTEM

(71) Applicant: Saudi Arabian Oil Company, Dhahran (SA)

(72) Inventor: Bruno Josso, Dhahran (SA)

(21) Appl. No.: 19/010,435

(22) Filed: Jan. 6, 2025

(51) Int. Cl. G05D 7/06

(52) U.S. Cl. CPC G05D 7/0688

(57) ABSTRACT

Devices, system and methods for flow regulating using an electronic flow-control assembly (EFCA) is provided. An EFCA includes a controller, a pump, a valve and a sensor. The valve is configured to receive a valve control signal from the controller and modulate a flow characteristic of a flow. The pump is configured to receive a pump control signal from the controller and modulate the flow characteristic of the flow. The sensor is configured to measure the flow characteristic of the flow and transmit a measurement signal associated with the measured flow characteristic to the controller. The controller is configured to receive an input reference signal, compare the measurement signal to the input reference signal, adjust the valve control signal and the pump control signal, and simultaneously send the adjusted valve control signal to the valve and the adjusted pump control signal to the pump.

### TECHNICAL FIELD

The present disclosure relates to a flow modulating system, and specifically to a system that can modulate a fluid flow characteristic based on an input electrical signal.

### BACKGROUND

A flow valve is a component used to manage and control the flow of fluids (for example, oil, gas, water, or a mixture of fluids) within pipelines and other equipment through which fluids flow. By integrating flow valves into a system, operators can manage the volume and direction of fluid flow. Flow valves function by opening or closing. When opened, these valves permit fluids to flow through designated paths, facilitating processes like distribution, mixing, or chemical reactions. Conversely, when closed, they block the passage, stopping the flow entirely.

A flow pump is a component that is designed to move fluids with efficiency and precision. A flow pump operates on the principle of transferring fluid by converting kinetic energy from an impeller into hydrodynamic energy. Other systems like, for instance, Archimedes' screw can also be used. Axial flow pumps are suited for situations requiring high flow rates and low pressure. Centrifugal pumps are used to handle a wide range of flow rates and pressures. The selection of a flow pump depends on application requirements, including the desired flow rate, the head, and the nature of the fluid being pumped.

In oil and gas industry, flow valves and flow pumps can be installed along oil and gas pipelines to regulate the rate of fluid flow. Flow valves can manage the pressure within the pipeline system and have the capability to completely stop or shut off the flow when necessary. In this sense, flow valves are flow attenuators. Flow pumps can drive fluid flow through the flowlines. In this sense, flow pumps are amplifiers.

### SUMMARY

The present disclosure describes methods, devices, systems and techniques for dynamic control of flow characteristics using an electronic flow control assembly (EFCA) or system. As described below, a flow valve and a flow pump are associated together on the same flowline under the supervision of a flow controller to allow for precise and continuous adjustment of flow.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A and 1B, each illustrates a schematic diagram of an example electronic flow-control assembly (EFCA).

FIG. 2A illustrates a cross-sectional view of an example EFCA.

FIG. 2B illustrates a schematic view of a jammer that can come to replace, or be added to the valve implemented in the example EFCA of FIG. 2A.

FIG. 3A illustrates a schematic view of a feedback loop implemented by the controller.

FIGS. 3B and 3C each illustrate a time series that is fed to the controller.

FIGS. 4A-4D illustrate example target dynamic waveform profile of a flow.

FIG. 5A illustrates a schematic view of a set of EFCAs assembled in parallel using a blender.

FIG. 5B illustrates a schematic view of a set of EFCAs assembled in parallel using a splitter and a blender.

FIG. 6A illustrates a schematic pseudo three-dimensional (3D) view of multiple EFCAs connected to a fluidic system to form an antenna capable of generating a mechanical wave (i.e., a wavefront).

FIGS. 6B-6D illustrate example wavefronts generated by the EFCA antenna of FIG. 6A.

FIG. 7 illustrates a flow chart of an example process to control a flow characteristic of a flow.

FIG. 8 illustrates a schematic of an electronic flow control system implementing constrained optimization relying on multiple sensors and corresponding set of values.

It is to be understood that the various exemplary implementations shown in the figures are merely illustrative representations and are not necessarily drawn to scale.

### DETAILED DESCRIPTION

Flow of fluids through flowlines or pipelines can be controlled using flow equipment such as pumps and valves. Pumps provide motive force to drive the fluid through the flowline. Valves control several aspects of fluid flow including, e.g., a flow rate, a direction of flow, to name a few. Sensors, e.g., flowmeters, pressure sensors, temperature sensors or other sensors, can be implemented in the flowline to sense characteristics (e.g., flow rate, pressure, temperature, or other characteristics) of the fluid as the fluid flows through the flowline.

This disclosure describes how an electronic flow-control assembly (EFCA) can be used to accurately control given characteristics of a flow in a pipe. As described below with reference to the following figures, the EFCA can modulate flow of fluid through a pipe based on an input electrical signal. For example, the EFCA can be fluidically coupled to a pipe through which fluid flows. The fluid is a carrier that carries physical characteristics, e.g., temperature, pressure or flow rate. An input electrical signal with a particular profile can be received as an input to the EFCA. Based on the profile of the input electrical signal, the EFCA can operate its components (described later) to transfer the profile of the input electrical signal onto fluid flowing through the pipe. By doing so, the EFCA can transduce an electrical characteristic of the input electrical signal into a physical characteristic of the flowing fluid. The physical characteristic can include, e.g., a flow rate, a flow pressure, a fluid temperature, or other characteristics. Other characteristics of the fluid include chemical characteristics such as pH or salinity.

In some aspects, an EFCA includes a pump, a valve, a sensor and a controller. The controller is configured to receive an input electrical signal based on which a given fluid flow characteristic is to be modulated. Based on the input electrical signal, the controller is configured to generate a valve control signal. The opening and closing of the valve are configured to be modulated in accordance with the valve control signal. In the context of this disclosure “opening” and “closing” are not equal to an ON state (100% open or 0% closed) and an OFF state (0% open or 100% closed), respectively, of the valve. Rather, the valve control signal can continuously adjust the state of the valve to be anywhere between 0% open (or 100% closed) and 100% open (or 0% closed). By doing so, the valve is configured to modulate a flow. Such modulation causes the valve to act as a flow attenuator. Also, based on the input electrical signal, the controller is configured to generate a pump control signal. The motive force generated by the pump is configured to be modulated in accordance with the pump control signal. By doing so, the pump is configured to modulate the flow and act as a flow amplifier. In flow operations, the pump, as a flow amplifier, and the valve, as a flow attenuator, operate antagonistically. As described here, the pump and the valve operate simultaneously in accordance with the pump control signal and the valve control signal, respectively, to modulate the flow through the pipe. The sensor is configured to measure a specific physical characteristic of the flow modulated by the valve and the pump, and transmit a measurement signal associated with the measured specific physical characteristic to the controller. The controller is configured to use the measurement signal as a feedback signal that is compared to the input electrical signal. The controller is configured to adjust the pump control signal and the valve control signal based on a result of the comparison between the feedback signal (i.e. the measurement signal) and the input electrical signal (i.e. the command). The controller is also configured to send the adjusted valve control signal to the valve and the adjusted pump control signal to the pump. The pump and the valve continue to modulate the flow in accordance with the adjusted pump control signal and the adjusted valve control signal, respectively. The feedback continues as a flow characteristic measured by the sensor approaches and substantially matches the profile of the input electrical signal. In the context of this disclosure “substantially matches” means a variation between the flow characteristic measured by the sensor and the profile of the input electrical signal. The variation is attributable to and depends on a time delay between a transfer of the profile of the input electrical signal to the fluid, and a corresponding response to the physical characteristic of the fluid. The input electrical signal can also be referred as the input reference signal in this disclosure.

Implementations of the present disclosure can provide one or more of the following technical advantages. For example, the implementation of this disclosure allows for precise control of dynamic flow characteristics (e.g., flow rate, volume, pressure, temperature, viscosity, density, pH value, chemical concentration, etc.) over time using an electronic flow-control assembly (EFCA) or system. This precise control can generate output flows that have waveform characteristics that are identical, or substantially identical, to those of the input electrical reference signals and are customized to meet specific requirements and desired characteristics. In addition, the techniques described in this disclosure allow for separate modulation of individual fluid flows to form an antenna capable of generating multiple types of wavefronts. These fluid flows can also be combined with at least one manifold to generate a single output flow with desired flow characteristics and/or split an input flow into multiple individual flows for independent modulation. The ability to modulate, split and blend fluid flows with precision offers flexibility in various applications. It can be applied in industries such as chemical processing, oil and gas production, water treatment, and manufacturing, where precise control over fluid dynamics is essential for optimizing processes and product quality.

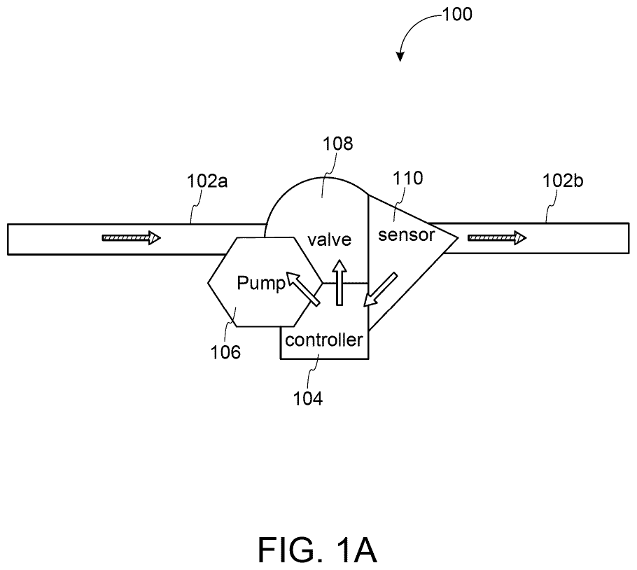

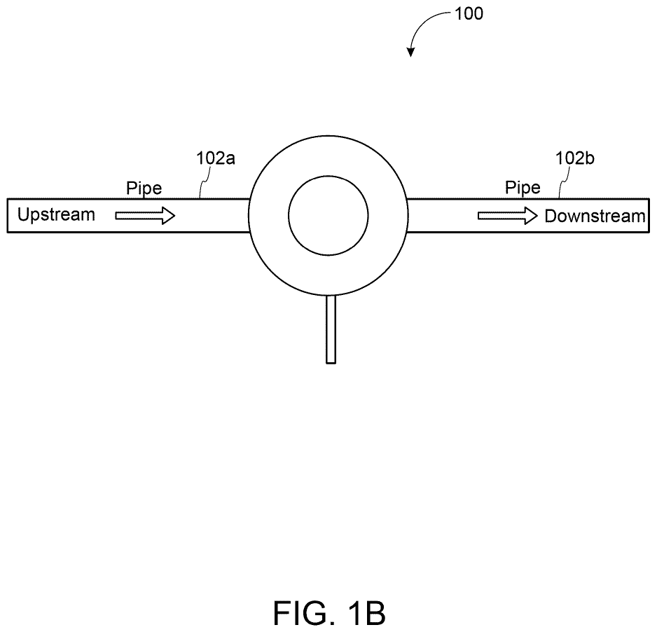

FIGS. 1A and 1B, each illustrates a schematic diagram of an example electronic flow-control assembly (EFCA). The EFCA 100 includes a controller 104, one or more valve 108, one or more pump 106 and one or more sensor 110. The valve 108, the pump 106 and the sensor 110 can be mechanically assembled to fluid pipe having an upstream fluid pipe section 102a and a downstream fluid pipe section 102b. For example, EFCA 100 can be fluidically coupled to a portion of the fluid pipe. The section of the pipe upstream of the EFCA 100 is the upstream fluid pipe 102a, and the section of the pipe downstream of the EFCA 100 is the downstream fluid pipe 102b. The EFCA 100 is configured to modulate and measure flow characteristics of the fluid in the pipes. In particular, the fluid flows through the upstream fluid pipe 102a towards the EFCA 100. The EFCA 100 modulates the fluid flow as described below. The fluid with the modulated flow characteristic flows downstream of the EFCA 100 through the downstream fluid pipe 102b. The flow characteristics can include flow rate, volume, pressure, temperature, viscosity, density, pH value, chemical concentration or other physical characteristic that can be carried by the flow. The upstream fluid pipe 102a and the downstream fluid pipe 102b can be referred to generally as pipe 102 in this disclosure.

The sensor 110 is typically positioned downstream, at the output of the assembly. In some implementations, an extra sensor 110b can be added and positioned upstream of the valve 108 or the pump 106. In some implementations, the valve 108, the pump 106 and the sensor 110 are directly exposed to the fluid flowing through the pipe 102 such that they can modulate or monitor the fluid.

In some implementations, the sensor 110 can be an array including multiple sensors. Such an array can measure all kinds of physical characteristics combinations. They can include two or more physical characteristics (e.g., flow rate and temperature, viscosity and pH and pressure, to name a few). The sensors of the array are typically distributed downstream at the output of the assembly (e.g., along the downstream pipe 102b). In some implementations, an extra array of sensors can be added upstream (e.g., along the upstream pipe 102a). All the sensors are always connected to the controller 104. In such implementations, the controller 104 can be configured to receive and process multiple input commands from the multiple sensors. In addition, the controller 104 can be configured to process the input commands simultaneously or separately, yet independently. For example, the controller 104 can be configured to receive input from a flowmeter and a salinity sensor at the same time, and yet process the input signals independently to generate corresponding valve control signals and pump control signals. Controlling several physical characteristics at the same time can lead to some contradictions. Therefore, when using arrays of sensors, the controller typically implements standard constrained optimization capabilities.

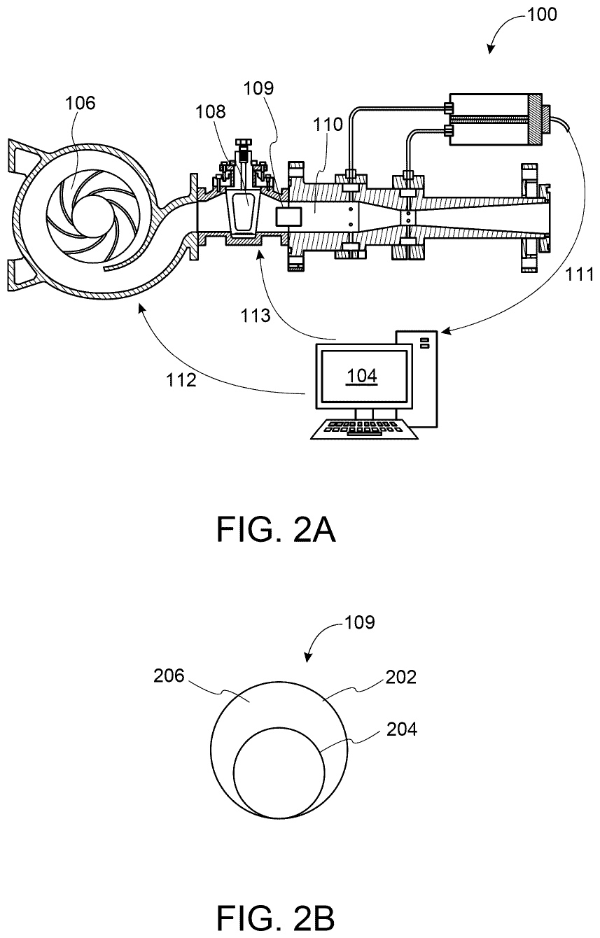

In some implementations, the valve 108, the pump 106, the sensor 110 and the controller 104 can be assembled together, as illustrated FIG. 2A. In some implementations, the controller 104 can be located remotely and communicate wirelessly with the valve 108, pump 106, and sensor 110. The controller 104 can also be referred to as the individual controller 104 in this disclosure. The arrangement and connections between the various components can be selected to avoid measurement time delays and communication delays between the various components.

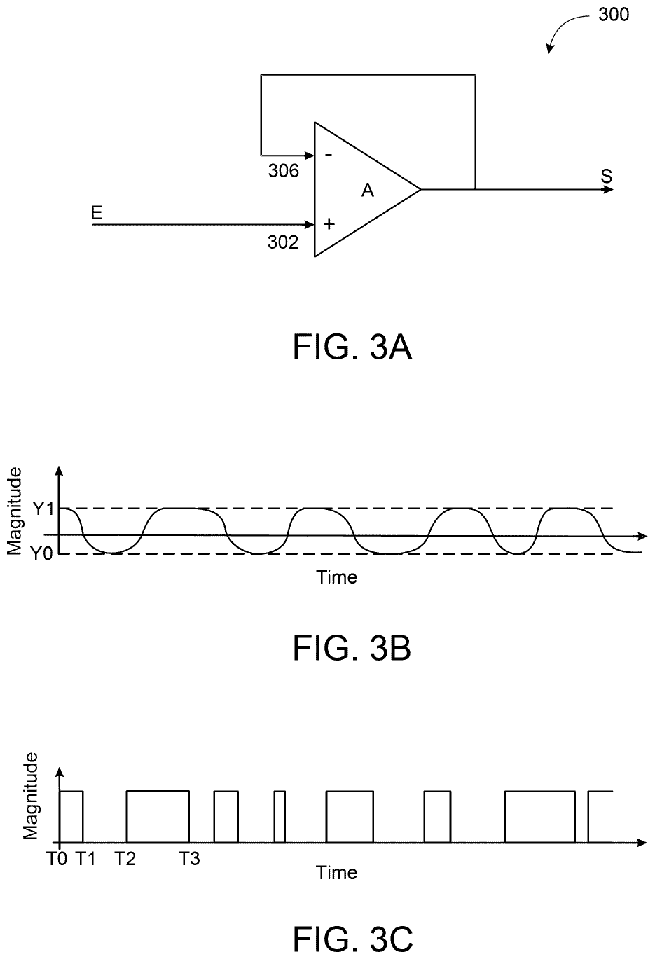

During operations, the controller 104 is configured to initially receive an input reference signal and responsively generate a first valve control signal and a first pump control signal based on the input reference signal. The input reference signal can be encoded with desired waveform profiles of dynamic flow characteristics. The controller 104 then simultaneously sends the first valve control signal to the valve 108 and the first pump control signal to the pump 106 for modulating the flow. Based on the first valve and pump control signals, the valve 108 can attenuate the flow rate of the fluid in the pipe 102, while the pump 106 can simultaneously amplify the flow rate of the fluid. Consequently, at least one flow characteristic (e.g., flow rate, volume, pressure) can be changed. Subsequently, the sensor 110 measures the modified flow characteristic and generates measurement signals corresponding to the measured flow characteristics. The measurement signal from the sensor 110 is an electrical signal (e.g., analog or digital, e.g., a voltage or current signal) that varies with the flow characteristics over time. This measurement signal is sent to the controller 104. The controller 104 then compares the actual flow characteristics (from the sensor 110) to the desired flow characteristics (input reference signals), as illustrated below in FIG. 3A. The controller 104 can typically implement a PID (Proportional, Integral, Derivative), which calculates the difference or error between the actual flow characteristics and the desired flow characteristics. To reduce this difference, the PID generates an adjusted valve control signal for the valve and an adjusted pump control signal for the pump to further modulate the flow characteristics. In particular, the controller 104 simultaneously sends the valve control signal to the valve 108 and the pump control signal to the pump 106. As the valve 108 and pump 106 adjust simultaneously, the flow characteristics (e.g., the flow rate) is further tuned. Multiple iterations of above steps can be conducted to minimize the difference between the actual flow characteristic and the desired flow characteristics. Such iterations are continuous and happen very rapidly; faster than the real time.

The valve 108 can include, without limitation to, a control valve, a rotary valve, a linear valve, a self-actuated valve, a quarter-turn valves, or a ball valve, as described with further details below in reference to FIG. 2A. The valve 108 is configured to receive a valve control signal from the controller 104 and modulate (e.g., decrease) a flow characteristic (e.g., a flow rate) of the flow, based on the valve control signal. For example, the valve 108 can include an actuator. The actuator can receive the control signal from the controller 104 and translates it into precise mechanical movement to adjust the valve position. Adjusting the valve's position can regulate the amount of fluid that can pass through, thus modulating the flow. In some implementations, the actuator switches the valve 108 between two positions: fully ON and fully OFF. In some implementations, the actuator allows the valve 108 to smoothly adjust its position between fully open and fully closed states, including various intermediate positions as needed. The actuator can be configured to have a fast response capability to high-frequency control signals such that the valve can promptly and accurately respond to variations in the control signals. In some implementations, the actuator can be a magnet or an engine.

In some cases, the flow characteristic of the fluid (e.g., volume, pressure, heat) can be modulated by controlling the flow rate of the fluid due to the inherent correlations between the flow characteristic and the flow rate. For example, if the pipe upstream 102a is connected to a source of hot water, attenuating the flow rate of the hot water also attenuates the amount of heat that is injected into the hydraulic system the EFCA is connected to.

In some implementations, the valve 108 is configured to modulate the flow rate proportionally based on the time-varying magnitude of the valve control signal it receives. For example, the reduction amount in a flow rate can be proportional to the magnitude of the valve control signal. In addition, or alternatively, the post-reduction flow rate can be proportional to the magnitude of the valve control signal. In some implementations, the valve control signal has a variable profile in a time domain. The valve control signal can include any bounded time series data.

The pump 106 can include, without limitation to, a surface pump, a centrifugal pump, a reciprocating pump, a screw pump, or a gear pump, as described with further details below in reference to FIG. 2A. The pump 106 is configured to receive a pump control signal from the controller 104 and modulate (e.g., increase) the flow characteristic (e.g., the flow rate) of the flow (see FIG. 1A) based on the pump control signal. For example, the pump 106 can include a motor as a driver. Similar to the actuator of the valve 108, the driver of the pump 106 can be configured to have a fast response capability to high-frequency pump control signals such that the driver can promptly and accurately respond to variations in the control signals.

In some implementations, the flow rate through a pump 106 is directly proportional to a pump speed. Therefore, the desired flow rate can be achieved by increasing or decreasing the pump's speed as specified by the pump control signal. In some implementations, the pump 106 can switch between two speed levels, or transition smoothly between two speed levels, including various intermediate positions as needed. In some implementations, the pump 106 is configured to increase a flow rate of the flow proportionally to a magnitude of the pump control signal. In some implementations, the pump control signal can be any bounded time series data. In some implementations, the pump control signal is different from the valve control signal.

In some implementations, when the flow to be generated is not too challenging, one of the active components of the assembly, either the valve or the pump, can be put “on hold”. For example, the valve can be left fully open. In another example, the pump can remain free flowing. In the first example, only the pump would contribute to modulating the flow. In the second example, only the valve would contribute to modulating the flow.

In a basic assembly configuration, when the command provided to the controller contains high frequencies, the pump and the valve forming the EFCA should be capable of reacting with the fastest possible response time. It is possible to characterize the response of the EFCA by operating an operation comparable to what is known in the O&G industry as build-up or draw-down tests. In short, it consists in feeding the controller of the EFCA with a controlled succession of pure step functions, for example running from 0% to 100%, or conversely from 100% to 0%, and simultaneously measuring the characteristics of the fluid at the output with sensors. The analysis of the measurement over the time can give the time/frequency characteristics of the global EFCA, and this way show the limits of its performances with a given fluid and given carried physical characteristics.

In some implementations, the controller 104 is configured to simultaneously send the pump control signal to the pump 106 and the valve control signal to the valve 108. The pump 106 and the valve 108 can be configured to have identical or substantially identical response time to the control signals such that they can modulate the underlying fluids at the same time.

The sensor 110 can include a flowmeter, as described with further details below in reference to FIG. 2A. The sensor 110 is configured to measure the flow characteristic of the flow in the downstream pipe 102b. In some implementations, a similar measurement in the upstream pipe 102a can also be operated. In some implementations, the flow characteristic includes at least one of flow rate, volume, pressure, temperature, viscosity, density, pH value, or chemical concentration. In some implementations, an array of two or more sensors 110 are deployed in the EFCA 100 to simultaneously measure various physical characteristics of the flow. In some implementations, the sensors 110 are configured to measure dynamic flow characteristics in real time. The sensors should be fast and precise enough to measure, without significant delay, the dynamics of the flow characteristics with sufficient accuracy. Measurement lags should be controlled to mitigate issues such as deviations and uncontrolled oscillations. The Proportional-Integral-Derivative (PID) implemented by the controller 104 is also in charge of mitigated such undesired effects.

The sensor 110 is further configured to transmit a measurement signal to the controller 104. The measurement signal is transmitted in real time. The measurement signal is associated with the measured physical characteristic of the flow. For example, when the sensor 110 is used to measure the flow rate within a pipe 102, variations in the magnitude of the measurement signal over time can indicate dynamic changes in the flow rate at specific measurement locations, e.g., where the sensors 110 are positioned on the pipe 102. When multiple sensors 110 are deployed, each sensor 110 can transmit a measurement signal to the controller 104 representing the corresponding dynamic flow characteristic it measures in real time. The multiple sensors can be positioned upstream or downstream (or both) of the EFCA 100. This can ensure that the flow characteristics of the upstream fluid correspond to the desired characteristics of the downstream fluid. For instance, if an EFCA is used as a water thermostatic mixer, it has to be connected to both a warm and a cold source of water. The temperature of each water supply source should be compatible with the temperature limits expected at the output of the EFCA.

The controller 104 can include a computer-readable medium (e.g., a non-transitory computer-readable medium) storing computer instructions executable by one or more processors. The one or more processors can execute the stored computer instructions to perform operations described in this disclosure. In some implementations, the controller 104 is a Proportional-Integral-Derivative (PID) controller. The controller 104 is configured to compare the measurement signal with an input reference signal to calculate errors. Based on the comparison result, the PID generates a valve control signal for the valve 108 and a pump control signal for the pump 106 to further modulate the flow. In particular, the controller 104 simultaneously sends the valve control signal to the valve 108 and the pump control signal to the pump 106. As the valve 108 and pump 106 adjust simultaneously, the flow characteristic (e.g., the flow rate) is further tuned. Multiple iterations can be conducted to reduce the difference between the actual flow characteristic and the desired flow characteristics.

It is to be understood that multiple pumps 106, multiple valves 108 and multiple sensors 110 can be included in the EFCA 100. Different sensors 110 can be utilized to measure diverse flow characteristics. The multiple pumps 106 and valves 108 can be coupled in parallel or in series to modulate the flow. The controller 104 can be configured to control all pumps and valves simultaneously based on multiple measurements provided by sets of sensors.

FIG. 2A illustrates a cross-sectional view of an example electronic flow-control assembly EFCA 100. It can be deployed above or below the surface of the Earth to control the fluid flow. As illustrated in FIG. 2A, the pump 106, the valve 108, and the sensor 110 can be assembled together between an upstream pipe 102a and a downstream pipe 102b (FIGS. 1A and 1B). They can each communicate remotely or by cable/optical fiber with the controller 104. FIG. 2A depicts a centrifugal pump 106, a plug valve 108 and a Venturi flowmeter 110 as an example. It is to be understood that other types of pump, valve, and sensor can be also deployed in the EFCA 100. It is also to be understood that in some implementations the EFCA 100 can include more than one pump, more than one valve or more than one sensor.

As noted above, the sensor 110 is used to measure one flow characteristic of the flow, or multiple characteristics when a set of sensors is used. Flow characteristics can include, without limitation to, flow rate, pressure, temperature, viscosity, density, pH value, color, or chemical concentration. The sensors 110 can translate the flow characteristics into electrical measurement signals and send the measurement signals to the controller 104.

In some implementations, the sensor 110 includes a flowmeter configured to quantify the movement of the flow moving through the pipe 102. The flowmeter can be a differential pressure flowmeter, a turbine flowmeter, an ultrasonic flowmeter or magnetic flowmeter. The differential pressure flowmeter measures the flow rate by determining the pressure drop across a flow restrictor. The turbine flowmeter has a rotor that spins when fluid passes through, where the rotor's speed is proportional to the flow rate. The ultrasonic flowmeter uses ultrasonic waves to determine the flow rate of the fluid flowing in the pipe 102. The magnetic flowmeter employs a magnetic field to measure the flow rate of conductive fluids.

In some implementations, the sensor 110 includes a pressure sensor configured to measure the pressure of the flow in the pipe 102. The pressure sensor can be a piezoelectric pressure sensor, which generates an electric charge in response to applied mechanical stress. The pressure sensor can also be a capacitive pressure sensor, which measures the pressure by determining the change in the capacitance.

In some implementations, the sensor 110 includes a salinity sensor for measuring salinity by assessing the conductivity of the fluid. In some implementations, the sensor includes a density sensor. For example, the sensor can be a vibrating element densitometer that measures density by determining the natural frequency change of a vibrating element in the fluid. In some implementations, the sensor includes an acidity (pH) sensor that measures pH by determining the potential difference between a pH electrode and a reference electrode. In some implementations, the sensor is a dryness sensor, which determines the water content in gas. For example, the dryness sensor can be a capacitive hygrometer, which measures moisture content by determining capacitance changes in a dielectric material due to water absorption. In some implementations, the sensor is a Hall-effect sensor, which measures the flow rate by determining changes in voltage due to magnetic field disruptions. The sensor can also be an optical encoder, which uses light patterns to determine rotational speed

The valve 108 can include a rotary valve, a linear valve, a self-actuated valve, a quarter-turn valve, a ball valve, a butterfly valve, a plug valve, a multi-turn valve, a globe valve, a gate valve, a needle valve, a solenoid valve, a coaxial valve, or an angle seat valve. The rotary valve utilizes a rotating closure component to block flow within a piping system. This rotation can continuously vary between 0 degree and 90 degrees and include more than two angular positions. The linear valve uses a flow obstructer, e.g., a disc, that moves straight to start, stop or adjust flow in the pipe 102, where the flow through the valve changes linearly in relation to the position of the flow obstructer. The ball valve can have a ball-shaped disc at their heart that controls the flow through them. The ball-shaped disc within the valve can be rotated to various positions, including fully open, fully closed, and intermediate states. The butterfly valves can use a center-mounted, disc-shaped obstructer that sways in and out of the piping system's flow. These quarter-turn valves can be used with larger pipe sizes and in wastewater plants, or power plants. The plug valves can be similar to ball valves in their construction and function. However, instead of using a ball-shaped obstructer, plug valves obstruct or allow flow via a tapered cylinder that swings into or out of the flow stream. The multi-turn valves (also called control valves in some cases) can work by cranking a handle to move an obstructer element into the flow path, which restricts flow within the piping system. Some types of multi-turn valves enable the flow to be released or blocked at variable speeds. The globe valve can have a spherical or cylindrical body with an internal baffle that directs the flow of fluid through the valve. The globe valves can include a valve body, stem, disc and actuator. The actuator is connected to the valve body and the stem, controlling the pressure and flow rate of the flow by adjusting the position of discs through the stem. The solenoid valves can use a linear sliding obstructer to open or shut the valve or redirect the flow from one outlet to another.

In some implementations, check valves are included. Check valves can be configured to direct the flow along a singular direction. They can be used to prevent backflow and protect the integrity of the fluidic system to which the EFCA is connected. Check valves can open and close automatically depending on the pressure of the fluid flowing through them. The check valves can be ball check valves, swing check valves, and gate check valves. The ball check valves can be used for low-pressure applications, while the swing check valves can be utilized in higher-pressure applications due to their enhanced reliability and durability. The gate check valves can be deployed in high-pressure and high-temperature applications, attributing to their tight sealing capability and high reliability. Check valves can be employed at the surface or within pipelines.

As noted above, the pump 106 can be used to modulate the flow rate of the fluid in the pipe 102. The selection of pumps can depend on both, the characteristics of the fluidic system to which the EFCA is connected, and the fluids that are involved. In some implementations, the pump 106 is a surface pump, a centrifugal pump, a reciprocating pump, a screw pump, a gear pump, a subsurface pump, an electric submersible pumps (ESP), a rod lift pump, a progressive cavity pumps (PCP), a hydraulic submersible pump, or a gas lift pump. The surface pump can be used for fluid transfer, boosting pressure in pipelines, and injecting chemicals or water into the fluidic systems to which the EFCA is connected. The centrifugal pump can utilize centrifugal force to convert rotational kinetic energy into hydrodynamic energy. They can be used in waterflooding operations for transfer of liquids. The reciprocating pumps can use a reciprocating motion to create a pumping action, which can be used in applications with high pressure and low volume, such as chemical injection. The screw pumps can include one or more screws to transfer fluids to handle viscous oils or multiphase fluids. The gear pumps can utilize interlocking gears to pump fluid by displacement, which can be deployed to transfer high viscosity fluids. The subsurface pumps are implemented below the ground surface, typically inside the wellbore, in the O&G context, to lift hydrocarbons from the reservoir to the surface. The ESP is a centrifugal pump driven by a submersible motor, which can be used in applications with high volume fluid, in deep reservoirs, or where reservoir pressure is insufficient for natural flow. The rod lift pump can use a reciprocating piston inside a cylinder that is operated via a sucker rod string, which can be used mature fields and stripper wells. The PCP utilizes a helical rotor and stator to lift fluid, which can be used in viscous crude, sandy reservoirs, and high water-cut wells. The hydraulic submersible pumps use hydraulic power to drive a downhole pumping mechanism, which can be deployed in deep wells with heavy crude and high gas-oil ratios. The gas lift pump injects high-pressure gas into the well to reduce the hydrostatic pressure of the column, allowing reservoir fluids to flow to the surface. The gas lift pump can revitalize under-performing wells or assist with initial production. It is to be understood that the list of sensors, valves and pumps described above is not intended to be exhaustive. Other suitable types of sensors, valves and pumps can also be considered for deployment.

FIG. 3A is an illustration of the feedback loop implemented by the controller 104. For example, the controller 104 can implement a differential amplifier. If the input reference signal 302 of the system is represented by E, if the output signal 306 of the system is represented by S, and the amplification generated by the system is represented by A, then the output 306 (S) can be represented by the following equation:

$$S = \frac{A}{1 + A} E$$

$${lim}_{A \to + ∞} S = E$$

Furthermore, one can see that:

In other words, the output(S) is equal to the input (E) if the amplification of the error (A) is big enough.

FIGS. 3B and 3C each illustrate the kind of time series that can be fed to the controller 104. In each of FIGS. 3B and 3C, the X-axis represents the time and the Y-axis represents the magnitude.

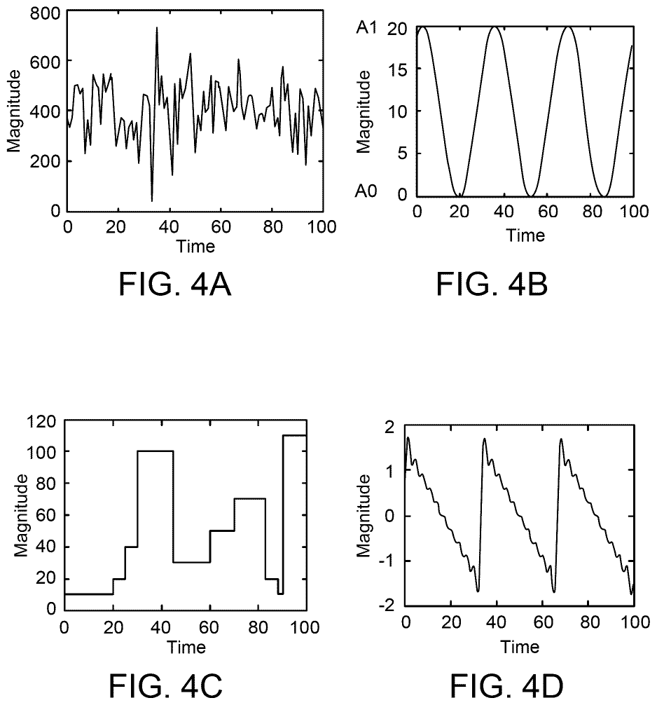

In some implementations, the controller 104 includes a Proportional-Integral-Derivative (PID) controller. The controller 104 is configured to receive inputs 111 (FIG. 2A) from all the sensors that are part of the assembly. Its role is to compare such signals with the corresponding targeted time series, which have been registered or are entered in real time, and bring the necessary corrections by calculating the commands that should be sent to the pump 112 (FIG. 2A) and the valve 113 (FIG. 2A) to minimize discrepancies between setpoints and actual outputs. In some implementations, the controller 104 can receive multiple measurement signals to be compared to as many input reference signals. The measurement signal 111 represents the actual measured flow characteristic, while the reference signal represents the waveform profile of the targeted physical characteristic carried by the fluid, for instance as illustrated in FIGS. 3B and 3C or FIGS. 4A to 4D. The controller 104 implements a closed loop system, which is configured to use the measurement signal 306 as a feedback signal that is compared to the input electrical reference signal 302. The controller 104 is configured to adjust the pump control signal 112 and the valve control signal 113 based on a result of the comparison between input and output. The controller is also configured to simultaneously send the adjusted valve control signal to the valve and the adjusted pump control signal to the pump. The pump and the valve continue to simultaneously modulate the flow in accordance with the adjusted pump control signal and the adjusted valve control signal, respectively. The feedback continues until the flow characteristic measured by the sensor substantially matches the profile of the input electrical signal. In addition, the controller 104 can be configured to control the potential instabilities inherent to closed-loop systems.

The input reference signal 302 can consist of any bounded time series with a waveform profile representing the targeted flow characteristic. For example, the input reference signal 302 can be a continuous signal (FIG. 3B), or a discrete signal or step function signal (FIG. 3C). The greater amplitude of the input reference signal 302 (e.g., Y1 in FIG. 3B) can refer to a greater value of the target flow characteristic (e.g., higher flow rate). Conversely, a lower amplitude of the input reference signal 302 (e.g., YO in FIG. 3B) can refer to a lower value of the target flow characteristic (e.g., lower flow rate). It is to be understood that input reference signals are not limited to the examples in FIGS. 3B and 3C.

In some cases, the properties of the mechanical components involved in the design of an EFCA 100, such as the pipe, pump, and valve, can influence the range of flow characteristics achievable by the fluid flow. Additionally, fluid properties, such as compressibility or Newtonian properties, can also impact modulation performance provided by the EFCA 100. Hence, the controller 104 can be configured to generate valve and pump control signals that are adapted and calibrated to maximize system capacity and accommodate various fluid types effectively.

FIGS. 4A-4D illustrate example of target waveform profiles of a flow characteristic. In the coordinate systems, the horizontal axis represents the time, whereas the vertical axis can represent the magnitude of a flow characteristic (e.g., flow rate) at the measurement location. For example, the target waveform profile of the flow characteristic can be a random profile (FIG. 4A), a sinusoidal signal (FIG. 4B), a piecewise signal resembling a step function signal (FIG. 4C), or a signal resembling a sawtooth wave signal (FIG. 4D). To obtain any of these target flow characteristics, the EFCA 100 can be supplied with the input reference signal 302 mirroring the intended target waveform profile of flow characteristics, as shown in FIGS. 4A-4D. As noted above, the input reference signal 302 is utilized by the controller 104 to generate valve control signals and pump control signals, which drive the valve 108 and pump 106 to modulate the flow to achieve the intended target flow characteristics.

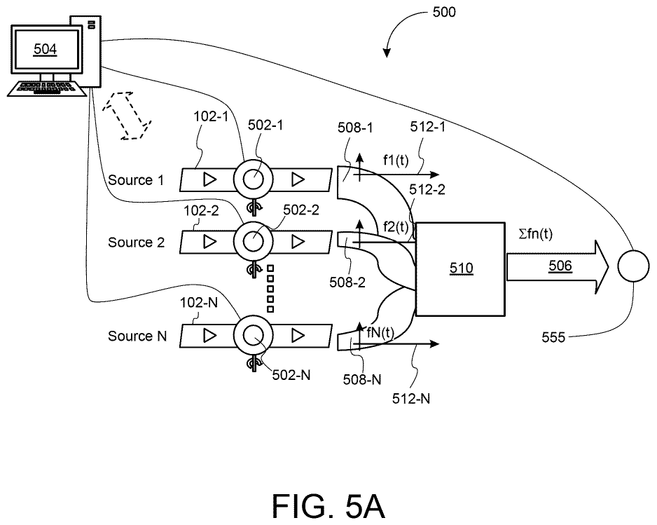

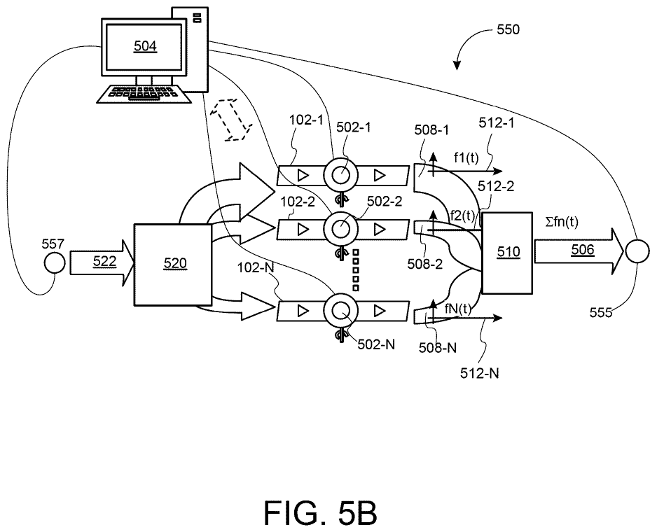

Alternatively, as the piecewise signals can be a sum of multiple step function signals, and the sawtooth signal can be a sum of multiple sinusoidal signals, these two waveform profiles can be achieved by merging two or more individual fluids (superposition principle), each independently modulated by their respective EFCA 100, as described with further details below in reference to FIG. 5A.

In some implementations, the target waveform profile of a flow characteristic is random (e.g., FIG. 4A). In such implementations, a mechanical jammer 109 (FIG. 2B) can be added to the EFCA, for example, between the valve 108 and the sensor 110 (FIG. 2A). The jammer 109 can be a piece of pipe 202, which can include a cavity 206 with an object 204 (e.g., a ball or similar object with a defined geometric shape), which can move within the cavity 206 without the possibility to find a stable position. As the fluid moves through the cavity 206, the object 204 continuously moves, thereby gently altering the flow to some extent, but without modifying the general trend. In this way, the jammer 109 can add some randomness to the physical characteristic carried by the flow. In such implementations, pumps and valves can be adjusted to give the sought averaged flow, which is the trend mentioned above. Sensors can be used to precisely measure the randomness of the jammer 109 as well as the trend. The EFCA can ensure that the sought average flow is correct and that the added randomness shows the right properties, i.e., that the random component of the flow shows the right color or, more technically, the expected power spectral density. If not, the EFCA can be programmed to bring the needed corrections by acting on both valves and pumps.

In some implementations, especially when a blender (described below) is used, a free check valve can be added at the output of each EFCA to prevent the fluid from flowing in the wrong direction, i.e. backward.

FIG. 5A illustrates a schematic view of a set of EFCAs assembled in parallel using a blender. The electronic flow-control system 500 includes multiple EFCAs (e.g., EFCA 502-1, 502-2, . . . 502-N, each similar to EFCA 100 of FIGS. 1A and 1B) and a unique master controller 504 (also referred to as the main orchestrator 504). Each EFCA in FIG. 5A is configured to be in communication with the orchestrator 504 for synchronous operation, usually electrically or optically. During operation, different upstream pipes (e.g., upstream pipe 102-1, 102-2 . . . 102-N, each similar to upstream pipe 102a of FIGS. 1A and 1B) can be connected to different fluid sources, e.g., cold water, hot water, or chemical solutions. The orchestrator 504 is configured to synchronously control each EFCA to modulate component flow in their respective pipe. Different EFCAs can perform different modulations. Therefore, after modulation, each downstream pipe carries modulated component fluid flow with its own flow characteristics. A single output flow 506 with the sought global flow characteristics can be obtained by merging these component fluids using a fluid blender (e.g., collection manifold 510). For instance, in a situation where cold water and hot water are each supplied through separate respective upstream pipes, resulting modulated flows can be directed to merge for the creation of a mixed flow that achieves a mild temperature output. Similarly, in the situations requiring pH value control, merging individual pipes containing various fluid with different acidity (e.g., acid flow and water flow) can provide a blended output flow with desired pH value. In such implementations, a sensor 555 can be connected to the output flow 506. The sensor 555 can also be connected to the orchestrator 504. The sensor 555 can be configured to measure physical characteristics of the global output flow 506 and communicate the same to the orchestrator 504. Using the measurement from the sensor 555, the orchestrator 504 can ensure that the sum of the flows corresponds to the single global command given to the orchestrator 504.

Each EFCA is mechanically coupled to a respective pipe, e.g., an upstreaming pipe and a downstream pipe. For example, the first EFCA 502-1 is assembled with the first pipe 102-1, the second EFCA 502-2 is assembled with the second pipe 102-2, and so forth. Each EFCA is configured to modulate the respective component flow in a manner identical or substantially similar to those described above. In some implementations, the EFCAs are configured to include sensors 110 capable of measuring different flow characteristics. For example, the sensor of the first EFCA 502-1 (which is similar to the sensor 110 of the EFCA 100 in FIG. 1A) can be a flowmeter which measures the flow rate of the first component flow in the first pipe 102-1, while the sensor of the second EFCA 502-2 can be a temperature sensor which measures the temperature of the second component flow in the second pipe 102-2. For example, such sensors measuring different fluid properties can be used when the sources of the fluids are different.

In some implementations, the electronic flow-control system 500 includes a fluid blender (e.g., a collection manifold 510) configured to receive the multiple modulated component fluid flows from the respective pipes and combine the multiple modulated component fluid flows to direct an output flow 506. For example, as illustrated in FIG. 5A, the collection manifold 510 can combine multiple modulated component flows 508-1, 508-2, . . . , 508-N into a single output flow 506. Also, each modulated component flow can be controlled by a respective check valve (e.g., check valves 512-1, 512-2, . . . , 512-N) Each check valve can ensure that reverse flows of the respective modulated component flows are stopped and also to avoid contamination of one output flow by any of the other output flows.

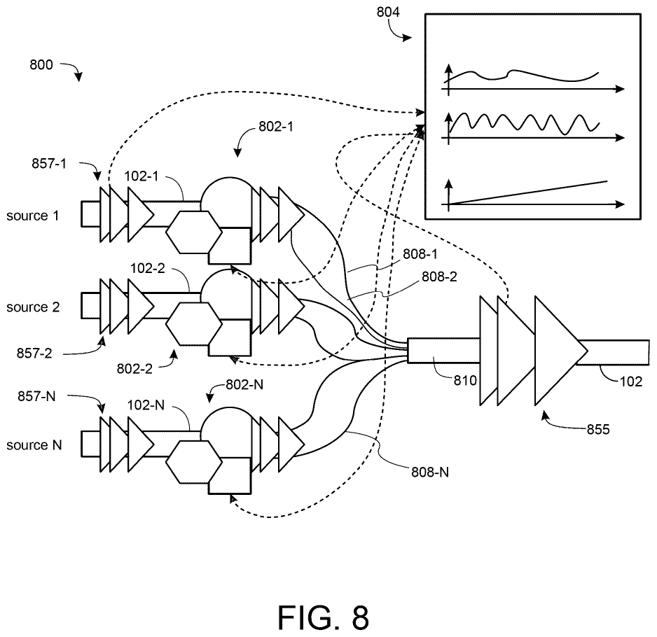

Each of the EFCA's 502-1, 502-2 . . . 502-N includes a respective, individual controller (not shown), each of which is similar to the controller 104 (FIG. 1A). Each such controller is coupled to a main unique orchestrator 504, for example, electrically or optically. As noted above, the orchestrator 504 is configured to synchronously control the EFCAs to modulate the flow characteristic of the respective component flow in the respective pipe. In some implementations, the orchestrator 504 is configured to receive a target output signal and determine the respective input reference signal (e.g., similar to the input reference signal 302 of FIG. 3A) for each EFCA based on the sought global target output signal (e.g., similar to the output signal 306 of FIG. 3A). This latter is encoded with the final desired waveform profile of flow characteristic for the output flow downstream of the distribution manifold 510. In some implementations, the orchestrator 504 is configured to receive multiple target output signals corresponding to multiple characteristics that should be carried by the fluid at the global output 506. In this latter case, arrays of sensors should be added both upstream and downstream as illustrated in FIG. 8. The orchestrator's role consists in, first comparing the target with the characteristics of the actual output flow, based on the measurements collected by the sensor, or the set of sensors, 555 located at the general output of the system, and second, generating corresponding bespoke corrections to be transmitted to each individual EFCA to minimize potential discrepancies. The input reference signals can be different for each EFCA. The orchestrator 504 then synchronously transmits each respective input reference signal to individual controller of the respective EFCA, such that all EFCAs modulate the respective component flow at the same time. As noted above, in each EFCA, individual controller is configured to determine the valve control signal and the pump control signal based on received input reference signal. In some implementations, the valve control signals or the pump control signals determined by at least two of the EFCAs are different. For example, the valve control signal for the first EFCA 502-1 can be different than that of the second EFCA 502-2. In addition, or alternatively, the pump control signal for the first EFCA 502-1 can be different than that of the second EFCA 502-2. As an illustration, the EFCA 502-n, with n in [1, N], can be set to generate N sinusoidal flows with N different magnitudes, phases and frequencies. If these factors are well defined by the orchestrator 504, it is possible, for instance to obtain a global output flow that resembles a sawtooth-like flow as illustrated in FIG. 4D.

In some implementations, the electronic flow-control system 500 is configured to generate complicated cyclic flow patterns from its use of Fourier Series principles by decomposing the complex waveform into simpler sine and cosine functions with different frequencies, magnitudes, and phases. For example, the input reference signal for each EFCA can be sinusoidal (sine waves), cosine waves, or combinations of both, as already illustrated above. By adjusting the coefficients of the Fourier Series representation (e.g., frequency, magnitude, or phase) in the input reference signals, dynamic flow characteristics of each component flow can be adjusted accordingly. The electronic flow-control system 500 can synthesize all modulated flows to achieve the complex cyclic patterns of flow characteristic in its output, which can be identically or substantially similar to the waveform profile of the target output signal received by the master unique orchestrator 504. For example, to have a flow characteristic with a waveform profile resembling a sawtooth wave (e.g., as illustrated in FIG. 4D) at the output of the collection manifold 510, a finite number of component fluid flows can be modulated to generate sinusoidal fluid waves with varying waveform profiles (such as frequency, magnitude, and/or phase) based on Fourier Series principles and then combined using the manifold 510. In another example, to have a waveform profile of a flow characteristic resembling a piecewise wave (e.g., as illustrated in FIG. 4C), the component fluid flows can be modulated to create step functions waves with varying waveform characteristics by using the superposition principle. In this latter case, valves and pumps pairs (not shown in FIG. 5A), can be operated sequentially, all together or separately. In this operation mode, pairs maintain a constant flow for a given time set by the orchestrator 504. The blender 510 operates the addition of the different flows.

In some implementations, multiple EFCAs are coupled in parallel, as illustrated in FIG. 5A. In some implementations, multiple EFCAs are coupled in series. For example, in a long-distance pipeline, two or more EFCAs can be installed at various points along the pipeline to regulate the flow. In such a setup, extra sensors positioned on the pipes 102a upstream, in addition of the default ones positioned downstream on the pipes 102b, are of great significance. More complex EFCA combinations including miscellaneous sources and in series/parallel assemblies can also be used.

FIG. 5B illustrates a schematic view of a set of EFCAs assembled in parallel using a splitter 520 and a blender 510. Compared to the electronic flow-control system 500 illustrated in FIG. 5A, the electronic flow-control system 550 can further include a fluid splitter (e.g., a distribution manifold 520) configured to receive an input flow 522, split the input flow 522 into the multiple component fluid flows and direct each along a respective one of the pipes 102. In such implementations, a sensor 557 can be connected to the input flow 522. The sensor 557 can also be connected to the orchestrator 504. The sensor 557 can be configured to measure physical characteristics of the input flow 522 and communicate the same to the orchestrator 504. Each component flow can subsequently undergo tailored modulation process by the corresponding EFCA 100 under synchronous control of the orchestrator 504. This allows for fine-tuning of the specific characteristics of flows to meet target flow characteristic. In some implementations, several splitters 520-1, 520-2, . . . , 520-K connected upstream to sources of diverse nature 522-1, 522-2, . . . , 522-K can be used in parallel and be connected to different sets of upstream pipes 102a-n.

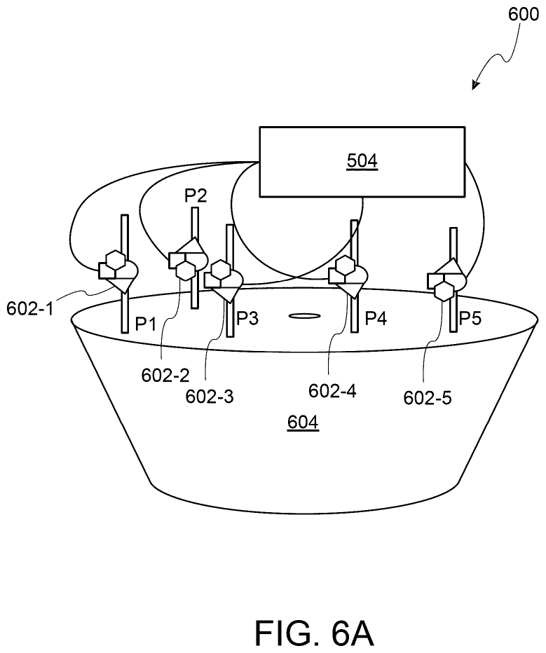

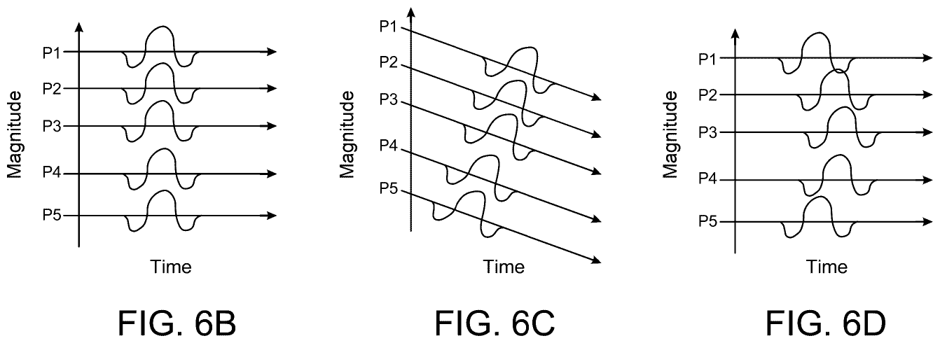

FIG. 6A illustrates a schematic view of multiple EFCAs (e.g., EFCAs 602-1, 602-2, . . . , 602-5) connected to a fluidic system 604 to form an antenna 600 capable of generating a controlled mechanical wave (i.e., a wavefront). For example, the fluidic system 604 can be an oil and gas (O&G) reservoir. The multiple EFCAs-based antenna 600 can be plugged at different geographical locations in the fluidic system 604. The individual EFCA 100 elements of the antenna 600 are connected to a unique orchestrator 504. For the sake of illustration, five EFCAs 602-1, 602-2, . . . , 602-5, are schematically shown in FIG. 6A. It is understood that any number of EFCAs can be used. The schematic diagram shown in FIG. 6A is a pseudo-three-dimensional representation of deploying the multiple EFCAs in a hydraulic system 604. The construction and principle of operation of the EFCAs is identical to those of the EFCAs shown schematically in FIGS. 5A and 5B.

The arrangement schematically shown in FIG. 6A can be used to form an EFCA antenna capable of generating emission beamforming by shaping mechanical wavefronts. This is usually executed by modifying the phase and the magnitude of each independent flow generated by each individual EFCA forming the antenna. Compared to the first implementation 500 and the second implementation 550 illustrated in FIGS. 5A and 5B, respectively, the third implementation of the electronic flow-control system 600 does not have a fluid blender 510 or a fluid splitter 520, although the addition of such elements on a sub selection of pipes upstream or downstream would not change the principle of the EFCA antenna described with reference to FIG. 6A. Therefore, individual fluid flows in each pipe remains physically separate from each other.

Multiple EFCAs can be positioned at different locations in the fluidic system 604, e.g. an O&G reservoir, and can work together to form the antenna. Antennas formed by the electronic flow-control system 600 generate controlled mechanical waves. The waveform profile of these mechanical waves carries time/space information. In that sense, fluids flowing through EFCAs can be considered as carriers. In some cases, when the antenna is utilized for injections of fluid (e.g., input), it can be called a transmitting antenna. When they are utilized for production of fluid (e.g., output), it can be called receiving antenna. In such a setup, extra sensors positioned on the pipes 102a upstream, in addition of the default ones positioned downstream on the pipes 102b, are of great significance. The orchestrator 504 can be configured to perform beamforming with the antenna, i.e., to adjust phases (i.e. time delay), frequencies and magnitudes of the flow at the output of each single EFCA 100 forming the antenna. By doing so, the antenna can shape a particular waveform profile transmitted to the fluidic system into which the antenna is plugged. This beamforming capability of the electronic flow-control system 600 can shape mechanical wavefronts according to desired angles and shapes as illustrated in FIGS. 6B-6D.

FIGS. 6B-6D illustrate example wavefronts generated by the set of EFCAs 100 and the orchestrator 504, when mounted to form an antenna. In the coordinate system, the horizontal axis represents the time, whereas the vertical axis represents the magnitude of flow characteristics (e.g., a flow rate or volume); FIGS. 6B-6D illustrates propagating waves. Observations are conducted at defined specific static locations in the fluidic system. Each of FIGS. 6B-6D includes multiple vertical axes labeled as P1, P2, P3, P4, and P5, which correspond to different underlying fluids at different locations, where EFCA are connected to the fluidic system 604, in FIG. 6A.

Specifically, FIG. 6B illustrates a plane wavefront travelling horizontally. FIG. 6C illustrates a plane wavefront travelling downward. FIG. 6D illustrates a circular wavefront. In this way, when coupling an antenna 600 to a fluidic system 604, as illustrated in FIG. 6A, this latter can be stimulated by all kinds of waves.

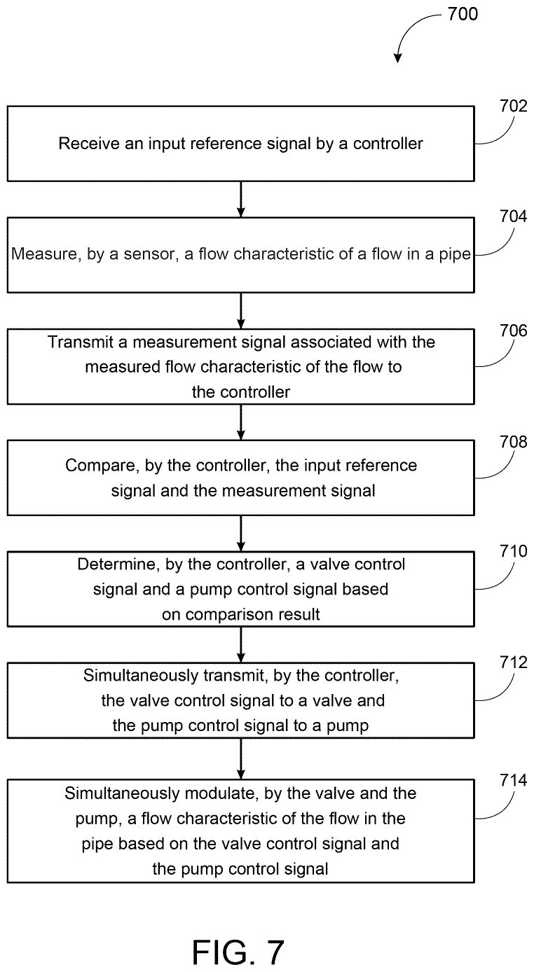

FIG. 7 illustrates a flow chart of an example process to control a flow characteristic of a flow. In some implementations, the controller 104 can implement the example process described with reference to FIG. 7. The controller 104 can implement the process in a continuous loop to control the output flow.

At step 702, an input reference signal 302 is received by a controller 104 with reference to FIG. 3A. As noted above, the controller 104 is configured to generate a first valve control signal and a first pump control signal based on the input reference signal. The input reference signals can be encoded with desired waveform profiles of dynamic flow characteristics. The controller 104 then simultaneously sends the first valve control signal to the valve 108 and the first pump control signal to the pump 106 for modulating the flow with reference to FIG. 2A. Based on the first valve and pump control signals, the valve 108 increases or decreases the flow rate of the fluid in the pipe 102 with reference to FIG. 1A, while the pump 106 simultaneously increases or decreases the flow rate of the fluid. Consequently, at least one flow characteristic (e.g., flow rate, volume, pressure) is changed.

At step 704, a flow characteristic of a flow in a pipe is measured by a sensor 110. The flow characteristic includes without limitation to flow rate, volume, pressure, temperature, viscosity, density, pH value, or chemical concentration. In some implementations, more than one sensor is utilized to measured different flow characteristics.

At step 706, a measurement signal 306 associated with the measured flow characteristic of the flow is transmitted from the sensor 110 to the controller 104 in real time.

At step 708, the input reference signal and the measurement signal are compared by the controller 104, as illustrated in FIG. 3A.

At step 710, a valve control signal and a pump control signal based on comparison result are determined by the controller 104. The controller 104 can be configured to determine the valve control signal and the pump control signal with the goal of minimizing the difference between the input reference signal 302 and the measurement signal 306.

At step 712, the valve control signal and the pump control signal are simultaneously transmitted by the controller 104 to a valve 108 and a pump 106 respectively.

At step 714, a flow characteristic of the flow in the pipe can be simultaneously modulated by the valve 108 and the pump 106 based on the valve control signal and the pump control signal, respectively. The modulated flow characteristic of the flow is again measured by the sensor, which is configured to transmit the measurement signal to the controller in real time. Multiple iterations of step 704 to step 714 can be conducted to continuously minimize the difference between the actual flow characteristic and the desired flow characteristics until the difference reaches a negligible value epsilon that can be made as small as needed depending on the sought result.

In some implementations, as described above in reference to FIG. 5B, an input flow 522 is split by a flow splitter (e.g., distribution manifold 520) into a plurality of component fluid flows, and each component fluid flow is directed along a respective pipe 102. A plurality of EFCAs 100 is mechanically coupled to the pipes 102. Each EFCA 100 includes at least a sensor, a valve and a pump. A flow characteristic of the component flows is modulated by EFCAs. A plurality of modulated component flows can be received by the fluid blender (e.g., collection manifold 510) from the respective pipe, which combines the plurality of the component flows into an output flow 506.

FIG. 8 illustrates a schematic of an electronic flow control system 800 implementing constrained optimization. The electronic flow control system 800 is substantially similar to the electronic flow control system 500 described above with reference to FIG. 5A. The electronic flow control system 800 includes a set of EFCAs (e.g., EFCA 802-1, 802-2, . . . 802-N, each similar to EFCA 100 of FIG. 1A, except that they include multiple sensors capable of measuring different physical fluid characteristics.). In FIG. 8 check valves designed to prevent backflows are not represented. They could be added to control the output flows 808-1, 808-2, . . . , 808-N that are mixed in the following fluid blender 810.

During operation, different upstream pipes (e.g., upstream pipe 102-1, 102-2 . . . 102-N, each similar to upstream pipe 102a of FIG. 1A) can be connected to different fluid sources, e.g., cold water, hot water, or chemical solutions. Multiple arrays of sensors (e.g., sensors 857-1, 857-2, . . . , 857-N), each similar to the sensor 557 of FIG. 5B, can be connected to respective upstream pipes.

An array of sensors 855 (similar to the sensor 555 of FIG. 5A) can be installed downstream of each EFCA and upstream of a collection manifold 810 (similar to the manifold 510), which is connected to a downstream pipe. The collection manifold 810 can receive and collect multiple modulated component flows 808-1, 808-2, . . . , 808-N into a single output flow that flows past the array of sensors 855 and through the downstream pipe 102.

The electronic flow control system 800 also includes a master orchestrator 804 substantially similar to the master orchestrator 504 of FIG. 5A. Each EFCA in FIG. 8 is configured to be in communication with the orchestrator 804 for synchronous operation. In addition, the orchestrator 804 is also in communication with each upstream array of sensors and each downstream array of sensors. Both upstream and downstream arrays of sensors are designed to measure the same set of physical characteristics. For instance, they can both measure pressure and temperature, salinity and pH value and opacity, etc.

The orchestrator 804 is configured to synchronously control each EFCA to modulate component flow in their respective pipe with different EFCAs capable of performing different modulations. Since controlling several physical characteristics at the same time can lead to some contradictions, the orchestrator 804 can be configured to implement constrained optimization algorithms. By implementing such algorithms, the orchestrator 804 can control several characteristics at the same time and can also handle multiple input commands that may be contradictory.

### Implementations

Certain aspects of the subject matter described here can be implemented as an EFCA. The EFCA includes a controller configured to receive an input reference signal and to responsively generate a valve control signal to control a valve and a pump control signal to control a pump. The valve control signal and the pump control signal are generated based on the input reference signal. A valve is electrically coupled to the controller and configured to be coupled to a pipe through which fluid flows. The valve is configured to receive the valve control signal from the controller and modulate a flow characteristic of the fluid in the pipe based on the valve control signal. A pump is electrically coupled to the controller and is configured to be coupled to the pipe through which fluid flows. The pump is configured to receive the pump control signal from the controller and modulate the flow characteristic of the fluid in the pipe based on the pump control signal. A sensor is electrically coupled to the controller and configured to be coupled to the pipe through which fluid flows. The sensor is configured to measure the flow characteristic of the fluid in the pipe and transmit a measurement signal associated with the measured flow characteristic to the controller. The controller is configured to compare the measurement signal to the input reference signal, adjust the valve control signal and the pump control signal based on a result of the comparing, and simultaneously send an adjusted valve control signal to the valve and an adjusted pump control signal to the pump.

An aspect combinable with any other aspect includes the following features. The flow characteristic includes at least one of flow rate, volume, pressure, temperature, viscosity, density, pH value, or chemical concentration.

An aspect combinable with any other aspect includes the following features. The flow characteristic is the flow rate. The valve is configured to decrease or increase the flow rate of the fluid in the pipe based on the valve control signal. The pump is configured to increase or decrease the flow rate of the fluid in the pipe based on the pump control signal.

An aspect combinable with any other aspect includes the following features. The valve is configured to increase or decrease the flow rate of the fluid in the pipe based on the adjusted valve control signal. The pump is configured to increase or decrease the flow rate of the fluid in the pipe based on the adjusted pump control signal.

An aspect combinable with any other aspect includes the following features. The sensor includes a flowmeter.

An aspect combinable with any other aspect includes the following features. The controller includes a Proportional-Integral-Derivative (PID) controller.

An aspect combinable with any other aspect includes the following features. The sensor is configured to transmit the measurement signal to the controller in real time.

An aspect combinable with any other aspect includes the following features. The sensor is positioned downstream of the valve and the pump.

An aspect combinable with any other aspect includes the following features. The assembly includes a jammer configured to be coupled to the pipe through which fluid flows. The jammer is installed between the valve and the sensor. The jammer is configured to introduce randomness in the fluid flow through the pipe.

An aspect combinable with any other aspect includes the following features. The jammer includes a piece of pipe configured to be coupled to the pipe through which fluid flows. The piece of pipe defines a cavity. An object is positioned within the cavity. The object is configured to move within the cavity in response to fluid flow through the piece of pipe.

Certain aspects of the subject matter described here can be implemented as an electronic flow-control system. The system includes a master orchestrator. The system also includes multiple EFCAs. Each EFCA is mechanically coupled to a respective pipe through which a respective component fluid flows. Each EFCA is also in electrical communication with the orchestrator. That orchestrator is configured to synchronously control the EFCAs to modulate a corresponding flow characteristic of the respective component fluid in the respective pipe. Each EFCA includes an individual controller electrically coupled to the orchestrator. The individual controller is configured to receive an input reference signal and to responsively generate a valve control signal to control a valve and a pump control signal to control a pump. The valve control signal and the pump control signal are generated based on the input reference signal. Each EFCA includes a valve electrically coupled to the individual controller and configured to be coupled to the pipe through which fluid flows. The valve is configured to receive the valve control signal from the individual controller and modulate a flow characteristic of the fluid in the pipe based on the valve control signal. Each EFCA includes a pump electrically coupled to the individual controller and configured to be coupled to the pipe through which fluid flows. The pump is configured to receive the pump control signal from the individual controller and modulate the flow characteristic of the fluid in the pipe based on the pump control signal. Each EFCA includes a sensor, or a set of multiple sensors, electrically coupled to the individual controller and configured to be coupled to the pipe through which fluid flows. The sensor is configured to measure the flow characteristic of the fluid in the pipe and transmit a measurement signal associated with the measured flow characteristic to the individual controller. The individual controller is configured to compare the measurement signal to the input reference signal, adjust the valve control signal and the pump control signal based on a result of the comparing, and simultaneously send an adjusted valve control signal to the valve and an adjusted pump control signal to the pump.

An aspect combinable with any other aspect includes the following features. The system includes a fluid blender configured to receive multiple modulated component fluid from the respective pipe and combine the multiple modulated component fluid to direct an output flow.

An aspect combinable with any other aspect includes the following features. The system includes a fluid splitter configured to receive an input flow, split the input flow into multiple component fluids and direct each along a respective pipe.

An aspect combinable with any other aspect includes the following features. The system includes multiple check valves, each mechanically coupled to a respective pipe through which the respective component fluid flows.

An aspect combinable with any other aspect includes the following features. The flow characteristic includes at least one of flow rate, volume, pressure, temperature, viscosity, density, pH value, or chemical concentration.

An aspect combinable with any other aspect includes the following features. The flow characteristic is the flow rate. The valve is configured to decrease the flow rate in the pipe based on the valve control signal, and the pump is configured to increase the flow rate in the pipe based on the pump control signal.

An aspect combinable with any other aspect includes the following features. The valve control signals or the pump control signals generated by at least two of the EFCAs are different.

An aspect combinable with any other aspect includes the following features. The controllers, and the main orchestrator when simultaneously using several EFCAs at the same time and arrays of multiple sensors, can implement constrained optimization algorithms.

Certain aspects of the subject matter described here can be implemented as a method to electrically control at least one flow characteristic. An input reference signal is received by a controller. A sensor measures a flow characteristic of a flow in a pipe. A measurement signal associated with the measured flow characteristic of the flow is transmitted to the controller. The controller compares the input reference signal and the measurement signal. The controller determines a valve control signal and a pump control signal based on comparison result. The controller simultaneously transmits the valve control signal to a valve and the pump control signal to a pump. The valve and the pump simultaneously modulate a flow characteristic of the flow in the pipe based on the valve control signal and the pump control signal.

An aspect combinable with any other aspect includes the following features. The flow characteristic of the flow includes at least one of flow rate, volume, pressure, temperature, viscosity, density, pH value, or chemical concentration.

An aspect combinable with any other aspect includes the following features. Multiple EFCAs are arranged. Each EFCA is mechanically coupled to a respective pipe through which a respective component fluid flows. Each includes the sensor, the valve, the pump and the controller. A respective EFCA modulates a corresponding flow characteristic of a respective component fluid. A fluid blender receives multiple modulated component fluids from a respective pipe and combines multiple component fluids to direct an output flow.

An aspect combinable with any other aspect includes the following features. A flow splitter splits an input flow into multiple component fluid and directs each along a respective one of multiple pipes.

An aspect combinable with any other aspect includes the following features. A unique master orchestrator, synchronously controls the EFCAs to modulate a corresponding flow characteristic of the respective component fluid in the respective pipe.

An aspect combinable with any other aspect includes the following features. Arrays of sensors can be used to simultaneously measure different fluid characteristics.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous. Moreover, aspects described with reference to any figure or any implementation can be combined with aspects described with any other figure or any other implementation.

The terms “real-time,” “real time,” “realtime,” “real (fast) time (RFT),” “near (ly) real-time (NRT),” “quasi real-time,” or similar terms (as understood by one of ordinary skill in the art) mean that an action and a response are temporally proximate such that an individual perceives the action and the response occurring substantially simultaneously. For example, the time difference for a response to display (or for an initiation of a display) of data following the individual's action to access the data may be less than 1 ms, less than 1 sec., less than 5 secs., etc. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit (or a combination of these or other functions) the data.

It is understood that the articles “a,” “an,” and “the” in this disclosure are intended to mean that there are one or more of the elements in the preceding descriptions. The terms “comprising,” “including,” and “having” are intended to be inclusive and mean that there may be additional elements other than the listed elements. Additionally, it should be understood that references to “one example” or “an example” of the present disclosure are not intended to be interpreted as excluding the existence of additional examples that also incorporate the recited features. For example, any element described in relation to an example herein may be combinable with any element of any other example described herein. Numbers, percentages, ratios, or other values stated herein are intended to include that value, and also other values that are “about” or “approximately” the stated value, as would be appreciated by one of ordinary skill in the art encompassed by examples of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to examples disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the examples that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

1. An electronic flow-control assembly (EFCA), comprising:
a controller configured to receive an input reference signal and to responsively generate a valve control signal to control a valve and a pump control signal to control a pump, the valve control signal and the pump control signal generated based on the input reference signal;
a valve electrically coupled to the controller and configured to be coupled to a pipe through which fluid flows, the valve configured to receive the valve control signal from the controller and modulate a flow characteristic of the fluid in the pipe based on the valve control signal;
a pump electrically coupled to the controller and configured to be coupled to the pipe through which fluid flows, the pump configured to receive the pump control signal from the controller and modulate the flow characteristic of the fluid in the pipe based on the pump control signal; and
a sensor electrically coupled to the controller and configured to be coupled to the pipe through which fluid flows, the sensor configured to measure the flow characteristic of the fluid in the pipe and transmit a measurement signal associated with the measured flow characteristic to the controller,
wherein the controller is configured to compare the measurement signal to the input reference signal, adjust the valve control signal and the pump control signal based on a result of the comparing, and simultaneously send an adjusted valve control signal to the valve and an adjusted pump control signal to the pump.

2. The electronic flow-control assembly of claim 1, wherein the flow characteristic comprises at least one of flow rate, volume, pressure, temperature, viscosity, density, pH value, or chemical concentration.

3. The electronic flow-control assembly of claim 2, wherein the flow characteristic is the flow rate, wherein the valve is configured to decrease or increase the flow rate of the fluid in the pipe based on the valve control signal, and the pump is configured to increase or decrease the flow rate of the fluid in the pipe based on the pump control signal.

4. The electronic flow-control assembly of claim 3, wherein the valve is configured to increase or decrease the flow rate of the fluid in the pipe based on the adjusted valve control signal, and the pump is configured to increase or decrease the flow rate of the fluid in the pipe based on the adjusted pump control signal.

5. The electronic flow-control assembly of claim 1, wherein the sensor comprises a flowmeter.

6. The electronic flow-control assembly of claim 1, wherein the controller comprises a Proportional-Integral-Derivative (PID) controller.

7. The electronic flow-control assembly of claim 1, wherein the sensor is configured to transmit the measurement signal to the controller in real time.

8. The electronic flow-control assembly of claim 1, wherein the sensor is positioned downstream of the valve and the pump.

9. The electronic flow-control assembly of claim 1, further comprising a jammer configured to be coupled to the pipe through which fluid flows, the jammer installed between the valve and the sensor, the jammer configured to introduce randomness in the fluid flow through the pipe.

10. The electronic flow-control assembly of claim 9, wherein the jammer comprises:
a piece of pipe configured to be coupled to the pipe through which fluid flows, the piece of pipe defining a cavity; and
an object positioned within the cavity, the object configured to move within the cavity in response to fluid flow through the piece of pipe.

11. An electronic flow-control system, comprising:
a master orchestrator; and
a plurality of electronic flow-control valve assemblies (EFCA), each mechanically coupled to a respective pipe through which a respective component fluid flows and in electrical communication with the orchestrator being configured to synchronously control the EFCAs to modulate a corresponding flow characteristic of the respective component fluid in the respective pipe, wherein each EFCA comprises:
an individual controller electrically coupled to the orchestrator, the individual controller configured to receive an input reference signal and to responsively generate a valve control signal to control a valve and a pump control signal to control a pump, wherein the valve control signal and the pump control signal are generated based on the input reference signal;
a valve electrically coupled to the individual controller and configured to be coupled to the pipe through which fluid flows, the valve configured to receive the valve control signal from the individual controller and modulate a flow characteristic of the fluid in the pipe based on the valve control signal;
a pump electrically coupled to the individual controller and configured to be coupled to the pipe through which fluid flows, the pump configured to receive the pump control signal from the individual controller and modulate the flow characteristic of the fluid in the pipe based on the pump control signal; and
a sensor electrically coupled to the individual controller and configured to be coupled to the pipe through which fluid flows, the sensor configured to measure the flow characteristic of the fluid in the pipe and transmit a measurement signal associated with the measured flow characteristic to the individual controller,
wherein the individual controller is configured to compare the measurement signal to the input reference signal, adjust the valve control signal and the pump control signal based on a result of the comparing, and simultaneously send an adjusted valve control signal to the valve and an adjusted pump control signal to the pump.

12. The electronic flow-control system of claim 11, comprising:
a fluid blender configured to receive a plurality of modulated component fluid from the respective pipe and combine the plurality of modulated component fluid to direct an output flow.

13. The electronic flow-control system of claim 12, comprising:
a fluid splitter configured to receive an input flow, split the input flow into a plurality of component fluid and direct each along a respective pipe.

14. The electronic flow-control system of claim 11, comprising: a plurality of check valves, each mechanically coupled to a respective pipe through which the respective component fluid flows.

15. The electronic flow-control system of claim 11, wherein the flow characteristic comprises at least one of flow rate, volume, pressure, temperature, viscosity, density, pH value, or chemical concentration.

16. The electronic flow-control system of claim 15, wherein the flow characteristic is the flow rate, wherein the valve is configured to decrease the flow rate in the pipe based on the valve control signal, and the pump is configured to increase the flow rate in the pipe based on the pump control signal.

17. The electronic flow-control system of claim 11, wherein the valve control signals or the pump control signals generated by at least two of the EFCAs are different.

18. The electronic flow-control system of claim 11, wherein the master orchestrator is configured to implement constrained optimization algorithms.

19. The electronic flow-control assembly of claim 11, wherein arrays of sensors capable of measuring different physical characteristics are used.

20. A method to electrically control at least one flow characteristic, comprising:
receiving an input reference signal by a controller;
measuring, by a sensor, a flow characteristic of a flow in a pipe;
transmitting a measurement signal associated with the measured flow characteristic of the flow to the controller;
comparing, by the controller, the input reference signal and the measurement signal;
determining, by the controller, a valve control signal and a pump control signal based on comparison result;
simultaneously transmitting, by the controller, the valve control signal to a valve and the pump control signal to a pump; and
simultaneously modulating, by the valve and the pump, a flow characteristic of the flow in the pipe based on the valve control signal and the pump control signal.

21. The method of claim 20, wherein the flow characteristic of the flow comprises at least one of flow rate, volume, pressure, temperature, viscosity, density, pH value, or chemical concentration.

22. The method of claim 20, comprising:
arranging a plurality of flow-control valve assemblies (EFCA) each mechanically coupled to a respective pipe through which a respective component fluid flows and each comprising the sensor, the valve, the pump and the controller;
modulating, by a respective EFCA, a corresponding flow characteristic of a respective component fluid; and
receiving, by a fluid blender, a plurality of modulated component fluids from a respective pipe and combining a plurality of component fluids to direct an output flow.

23. The method of claim 22, comprising:
splitting, by a flow splitter, an input flow into a plurality of component fluid and direct each along a respective one of a plurality of pipes, the plurality of component fluid comprising the flow, the plurality of pipes comprising the pipe.

24. The method of claim 21, comprising: synchronously controlling, by a master orchestrator, the EFCAs to modulate a corresponding flow characteristic of the respective component fluid in the respective pipe.
